(19) United States
(12) Patent Application Publication
(10) Pub. No.: US 2008/0100702 A1
(43) Pub. Date: May 1, 2008

(54) ELECTRONIC ENDOSCOPE

(75) Inventor: Katsuya Tannai, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/924,739

(22) Filed: Oct. 26, 2007

(30) Foreign Application Priority Data
Oct. 30, 2006 (JP) 2006-294367

(51) Int. Cl. H04N 7/18

(52) U.S. Cl. 348/65; 348/E07.087

(57) ABSTRACT

An electronic endoscope has a first signal-reading processor, a second signal-reading processor, and a color-adjustment processor. The first signal-reading processor reads image-pixel signals from an image sensor in accordance with a first signal-reading method that obtains a moving image. The second signal-reading processor reads image-pixel signals from the image sensor in accordance with a second signal-reading method that obtains a still image. The color-adjustment processor carries out a color-adjustment process on image signals generated from the image-pixel signals. Then, a calculation processor of the electronic endoscope calculates first and second color-adjustment coefficients that are used in the color-adjustment process. The calculation processor calculates the first color adjustment coefficients by operating the first signal-reading processor, and calculates the second color-adjustment coefficients by operating the second signal-reading processor.

### BACKGROUND OF THE INVENTION

1. Field of the Invention

The present invention relates to an electronic endoscope that is capable of displaying a moving image and a still image. In particular, it relates to a color-adjustment process such as a white-balance adjustment process.

2. Description of the Related Art

In an electronic endoscope, a moving image is displayed on a monitor by using an interline-transfer type CCD, and also, a still image can be displayed and recorded by using the interline-transfer CCD. In normal observation mode, during each field interval, odd-field image-pixel signals and even-field image-pixel signals are alternately read from the CCD. On the other hand, when displaying and/or recording a still image (i.e., when carrying out a so-called “freeze operation”), one whole frame's worth of image-pixel signals obtained from a single exposure are generated and read from the CCD. Namely, odd-line image-pixel signals and even-line image-pixel signals are read from the CCD, sequentially, within two field intervals. Consequently, a high-quality still color image without blur is obtained.

In order to reproduce the color of a photographed subject accurately regardless of the type of light source, a white-balance adjustment process is carried out. First, before an electronic endoscope is inserted into a body, white-balance coefficients are calculated in a situation in which a white object is captured. Then, during an observation, R, G, and B primary color image signals are corrected by multiplying the calculated white-balance coefficients, i.e., R, G, and B gain values. The R, G, and B gain values are determined such that the ratio of R, G, and B signal values becomes 1:1:1.

Color components in image signals vary with the array-pattern of color elements on a color filter and the signal-reading method. Since the signal-reading method for a still image is different from that for a moving image, color components in still image signals are different from those in moving image signals. Therefore, the color tone of a captured still image which is color-adjusted the same way as a moving image, does not match the moving image.

### SUMMARY OF THE INVENTION

An object of the present invention is to provide an electronic endoscope or apparatus/method for adjusting the colors on an image that is capable of producing a moving image and a corresponding still image with common color tone.

An electronic endoscope according to the present invention has a video scope with an image sensor. A subject image is formed on the image sensor by light passing through a color filter. The electronic endoscope also has a first signal-reading processor, a second signal-reading processor, and a color-adjustment processor. The first signal-reading processor reads image-pixel signals from the image sensor in accordance with a first signal-reading method that obtains a moving image. The second signal-reading processor reads image-pixel signals from the image sensor in accordance with a second signal-reading method that obtains a still image. The color-adjustment processor carries out a color-adjustment process to image signals generated from the image-pixel signals.

For example, the color filter may be a complimentary color filter. Also, the first signal-reading processor may read the image-pixel signals from the image sensor by a field-reading method. The second signal-reading processor may read the image-pixel signals from the image sensor by a frame-reading method.

In the present invention, the electronic endoscope has a calculation processor that calculates first and second-color adjustment coefficients that are used in the color-adjustment process. The calculation processor calculates the first color adjustment coefficients by operating the first signal-reading processor, and calculates the second color-adjustment coefficients by operating the second signal-reading processor. Since the first color-adjustment coefficients suitable for a moving image and the second color adjustment coefficients suitable for a still image are obtained independently, appropriate color-adjustment is carried out on both the moving image and the still image.

In order to obtain the first and second color adjustment coefficients at once, the calculation processor may calculate the first and second color-adjustment coefficients continuously. For example, the calculation processor calculates the first color-adjustment coefficients first, and then calculates the second correction coefficients. To obtain the color-adjustment coefficients desired by the operator, an operation member is provided. The operation member is operated to start calculating the first and second color-adjustment coefficients.

An apparatus for calculating color-adjustment coefficients, according to another aspect of the present invention, has a first signal-reading processor that reads image-pixel signals from the image sensor in accordance with either a moving-image signal-reading method that obtains a moving image, or a still-image signal-reading method that obtains a still image. It also has: a first calculation processor that calculates first color adjustment coefficients used in a color-adjustment process on the basis of the image-pixel signals obtained by the first signal-reading processor; a second signal-reading processor that reads image-pixel signals from the image sensor in accordance with the other signal-reading method; and a second calculation processor that calculates second color-adjustment coefficients on the basis of the image-pixel signals obtained by the second signal-reading processor.

A computer-readable medium that stores a program for calculating color-adjustment coefficients, according to another aspect of the present invention, has a first signal-reading process code segment that reads image-pixel signals from the image sensor in accordance with either a moving-image signal-reading method that obtains a moving image, or a still-image signal-reading method that obtains a still image. It also has: a first calculation process code segment that calculates first color-adjustment coefficients used in a color adjustment process on the basis of the image-pixel signals obtained by the first signal-reading process code segment; a second signal-reading process code segment that reads image-pixel signals from the image sensor in accordance with another signal-reading method; and a second calculation process code segment that calculates second color-adjustment coefficients used in a color-adjustment process on the basis of the image-pixel signals obtained by the second signal-reading code segment.

A method for calculating color-adjustment coefficients, according to another aspect of the present invention, includes: a) reading image-pixel signals from the image sensor in accordance with either a moving-image signal-reading method that obtains a moving image, or a still-image signal-reading method that obtains a still image; b) calculating first color-adjustment coefficients used in a color-adjustment process on the basis of the image-pixel signals obtained by one signal-reading processor; c) reading image-pixel signals from the image sensor in accordance with the other signal-reading method; and d) calculating second color-adjustment coefficients on the basis of the image-pixel signals obtained by the other signal-reading method.

### BRIEF DESCRIPTION OF THE DRAWINGS

The present invention will be better understood from the description of the preferred embodiments of the invention set forth below together with the accompanying drawings, in which:

FIG. 1 is a block diagram of an electronic endoscope according to the first embodiment;

FIGS. 2A and 2B are views showing signal reading methods for pixel signals;

FIG. 3 is a schematic diagram of the latter signal-processing circuit;

FIG. 4 is a flowchart of a white-balance coefficient operation process performed by the system control circuit; and

FIG. 5 is a flowchart of a white-balance coefficient operation process according to the second embodiment.

### DESCRIPTION OF THE PREFERRED EMBODIMENTS

Hereinafter, the preferred embodiments of the present invention are described with reference to the attached drawings.

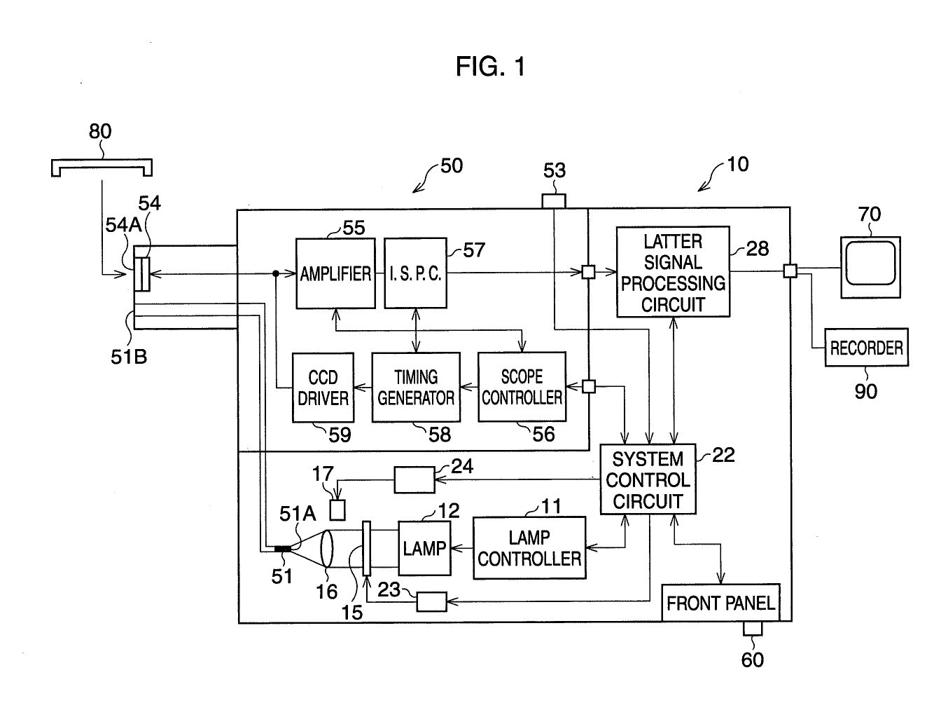

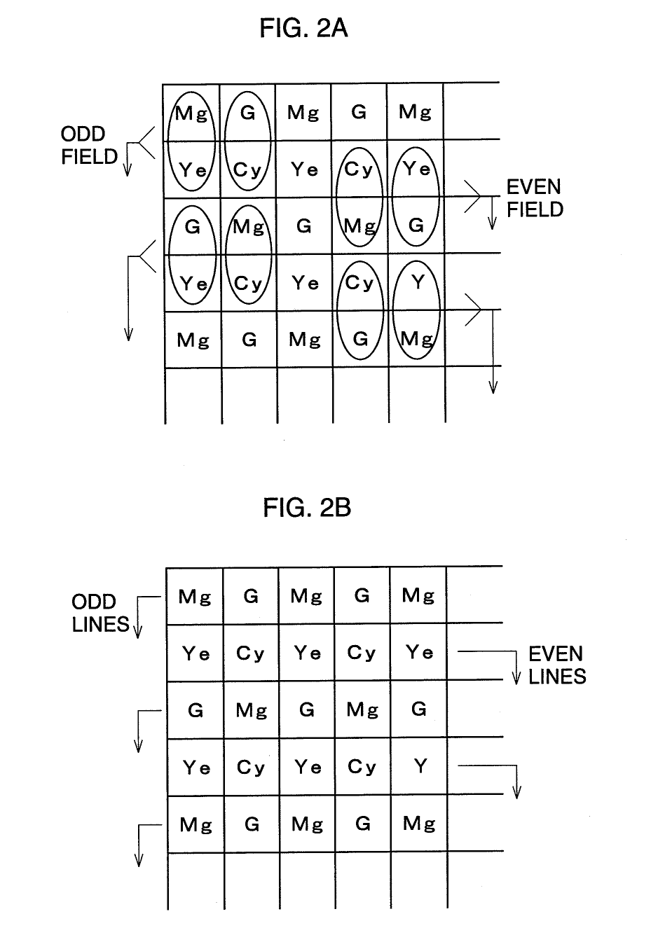

FIG. 1 is a block diagram of an electronic endoscope according to the first embodiment. FIGS. 2A and 2B are view showing signal reading methods for pixel signals.

An electronic endoscope is equipped with a video scope 50 having a CCD 54 and a video processor 10. The video scope 50 is removably connected to the video processor 10, and a monitor 70 and a recorder 90 are connected to the video processor 10.

When a lamp switch (not shown) is turned on, electric power is supplied from a lamp controller 11 to a lamp 12, so that the lamp 12 emits white light. The emitted light passes through a rotary shutter 15 and a collecting lens 16, and enters into an incident surface 51A of a light guide 51. The light guide 51, composed of a fiber-optic bundle, directs the light to the tip portion of the video scope 50. The light, passing through the light guide 51, exits from the tip 51B of light guide 51, and exits from the tip of the video scope 50 via a diffusion lens (not shown), so that a subject may be illuminated.

Light reflected off the subject passes an objective lens (not shown) and reaches the CCD 54, so that an object image is formed on a photo-sensor area of the CCD 54. On the photo-sensor area of the CCD 54, a complementary color filter 54A, checkered by four color elements, Yellow (Y), Magenta (Mg), Cyan (Cy), and Green (G), is arranged such that each area of the four color elements is opposite a pixel.

In the CCD 54, analog image-pixel signals are generated by the photoelectric effect, based on light passing through the complementary color filter. ACCD driver 59 outputs clock pulse signals to the CCD 54 so that the image-pixel signals are read from the CCD 54 at regular time intervals. Herein, the NTSC or PAL standard is applied; therefore, one field's-worth of image-pixel signals are read from the CCD 13 successively at 1/60- or 1/50-second time intervals. In accordance with the method of pixel mixture reading, which is one method of a field reading, odd-field image-pixel signals and even-field image-pixel signals are read from the CCD 54 alternately. Specifically, neighboring two pixels along the vertical direction are added in the odd-field interval and the even-field interval (see FIG. 2A). The image-pixel signals are then fed to an initial signal-processing circuit 57 via an amplifier 55. In the initial signal-processing circuit 57, a given process is performed on the image-pixel signals. The processed analog image-pixel signals are fed from the initial signal-processing circuit 57 to a latter signal-processing circuit 28 in the video processor 10.

In the latter signal-processing circuit 28, various processes, including a white-balance adjustment process and a gamma-correction process, are performed on the image-pixel signals, so that luminance and color-difference signals are generated. The luminance and color-difference signals are directly output to the monitor 70. Thus, a full-color moving image is displayed on the monitor 70.

When a freeze button 53, provided on the video scope 50, is operated to carry out a freeze operation, one frame's worth of image-pixel signals, obtained in a single exposure, are read from the CCD 54 in two interlaced fields in accordance with a so-called “frame reading method”. Namely, even-line image-pixel signals and odd-line image-pixel signals are read from the CCD 54 in two field-reading intervals, sequentially (see FIG. 2B).

The one frame's worth of image-pixel signals are sent to the latter signal processing circuit 28 via the amplifier 55 and the initial signal-processing circuit 57. In the latter signal-processing circuit 28, still-image signals for displaying a full-color still image on the monitor 70 are generated. Furthermore, the digitized image-pixel signals are transmitted to the recorder 90.

The rotary shutter 15, provided between the lamp 12 and the collective lens 16, rotates at a constant speed by driver signals output from a rotary shutter driver 23. The rotary shutter 15 has an open portion and a blocking portion, which periodically block light from the lamp 12 and define the exposure time for each field interval. A pivotable chopper 17 is provided between the rotary shutter 15 and the collective lens 16, and moves on the basis of driver signals sent by a chopper driver 24. In the freeze operation, the chopper 17 moves a blocking position while the even-line image-pixel signals are read from the CCD 54.

A system control circuit 22, including a CPU (not shown), ROM unit, and RAM unit, controls the video processor 10, and outputs control signals to circuits in the video processor 10. In the ROM unit, a program associated with a white-balance adjustment process is stored. A timing generator (not shown) in the video processor 30 outputs clock pulse signals to adjust the timing of a signal process. A scope controller 56 in the video scope 10 controls the video scope 50, and outputs control signals to the initial signal-processing circuit 57 and a timing generator 58. When the video scope 50 is connected to the video processor 10, data is transmitted between the scope controller 56 and the system control circuit 22. Also, when the freeze button 53 is operated, the system control circuit 22 in the video processor 10 outputs a control signal to the scope controller 56, and the scope controller 56 outputs control signals to the CCD driver 59 to change the signal-reading method.

Before inserting the endoscope 10 into a body to diagnose an organ, the tip of the video scope 10 is inserted into a cylinder 80 having an inner white surface. Then, as described below, when a white-balance button 60, provided on the front panel of the video processor 10, is operated by an operator, a series of white-balance coefficients for a moving image and for a still image are calculated simultaneously.

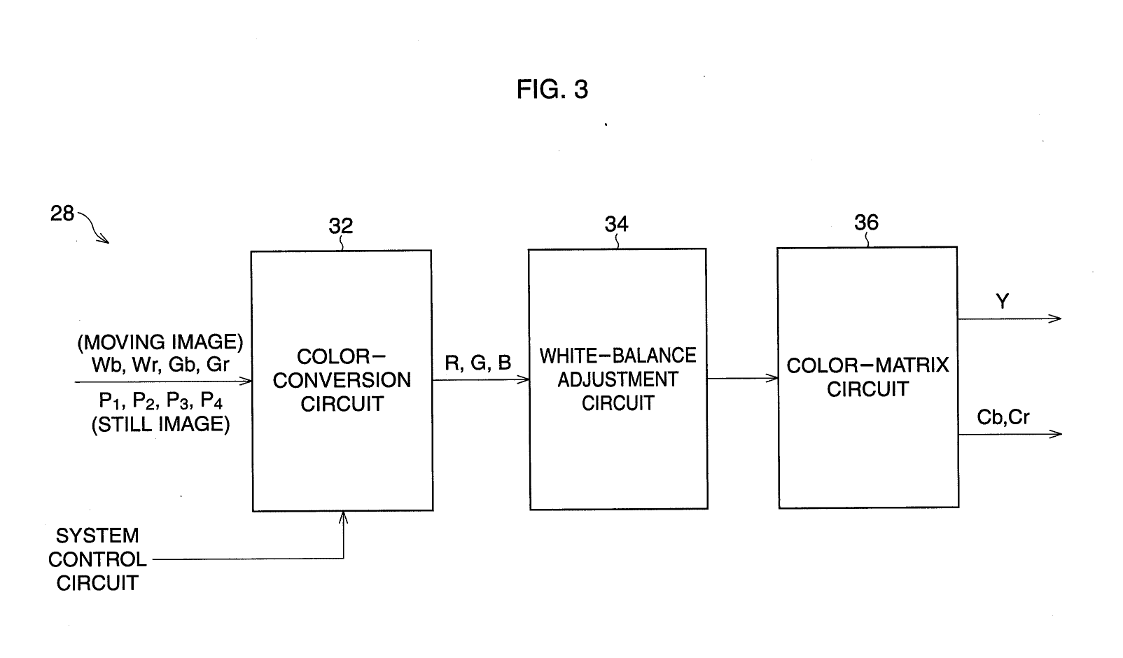

FIG. 3 is a schematic diagram of the latter signal-processing circuit 28. Herein, only circuits associated with a white-balance adjustment process are shown.

The latter signal-processing circuit 28 has a color-conversion circuit 32, a white-balance adjustment circuit 34, and a color-matrix circuit 36. Based on a control signal from the system control circuit 22, the latter signal-processing circuit 28 selectively carries out a signal process of image-pixel signals for a moving image, or a signal process of image-pixel signals for a still image.

When displaying a moving image, in the color-conversion circuit 32, odd-field image-pixel signals are sampled and held while even-field image-pixel signals are read from the CCD 54. Then, based on the odd- and even-field image-pixel signals, a matrix operation is carried out in each block, which is composed of the neighboring four pixels. When representing added pixels according to the pixel-mixture reading method by “Wb, Wr, Gb, and Gr” respectively, R, G, and B color image signals are calculated from the following formula using a 3×4 matrix K. Note, when representing four pixels opposite four color elements, “Cy, Mg, Ye, and G” as “P₁, P₂, P₃, and P₄”, the added pixels Wb, Wr, Gb, and Gr are equal to (P₁+P₂), (P₁+P₄), (P₃+P₄), and (P₂+P₃), respectively. The matrix K is composed of matrix coefficients kᵢⱼ (1≦i≦3, 1≦j≦4).

$$( \begin{matrix}R \\ G \\ B\end{matrix} ) = ( \begin{matrix}{k}_{11} , {k}_{12} , {k}_{13} , {k}_{14} \\ {k}_{21} , {k}_{22} , {k}_{23} , {k}_{24} \\ {k}_{31} , {k}_{32} , {k}_{33} , {k}_{44}\end{matrix} ) ( \begin{matrix}W b \\ G b \\ W r \\ G r\end{matrix} ) \qquad ( 1 )$$

The R, G, and B color image signals generated by the matrix K are subjected to a white-balance adjustment process in the white-balance adjustment circuit 34. Namely, the values of R, G, and B color image signals are multiplied by white-balance coefficients, i.e., R, G, and B gain values. The white-balance coefficients for a moving image are pre-calculated in the white-balance coefficient operation process described below, and stored in a register (not shown) provided in the white-balance adjustment circuit 34.

The white-balance adjusted R, G, and B color image signals are subjected to various processes, such as a color-interpolation process and a gamma-correction process, and sent to the color-matrix circuit 36. In the color-matrix circuit 36, luminance and color difference signals Y, Cb, and Cr are generated from the processed R. G, and B color image signals. The luminance and color-difference signals Y, Cb, and Cr are output to the monitor 70.

On the other hand, in the case of the freeze operation, the color-conversion circuit 32 samples and holds odd-line image-pixel signals while the even-line image-pixel signals are read from the CCD 54. Then, a matrix operation is carried out on each block composed of four neighboring pixels P₁, P₂, P₃, and P₄. The values of R, G, and B color image signals are obtained based on the following formula using a 3×4 matrix M. The matrix M is composed of matrix coefficients mᵢⱼ (1≦i≦3, 1≦j≦4).

$$( \begin{matrix}R \\ G \\ B\end{matrix} ) = ( \begin{matrix}{m}_{11} , {m}_{12} , {m}_{13} , {m}_{14} \\ {m}_{21} , {m}_{22} , {m}_{23} , {m}_{24} \\ {m}_{31} , {m}_{32} , {m}_{33} , {m}_{44}\end{matrix} ) ( \begin{matrix}{P}_{1} \\ {P}_{2} \\ {P}_{3} \\ {P}_{4}\end{matrix} ) \qquad ( 2 )$$

The generated R, G, and B color image signals are subjected to the white-balance adjustment process in the white-balance adjustment circuit 34. Namely, the generated R, G, and B color image signals are multiplied by white-balance coefficients for a still image. The white-balance coefficients for a still image are also pre-calculated in the white-balance coefficient operation process, and stored in the register of the white-balance adjustment circuit 34. The white-balance-adjusted R, G, and B color image signals are subjected to the matrix operation so that luminance and color difference data are generated.

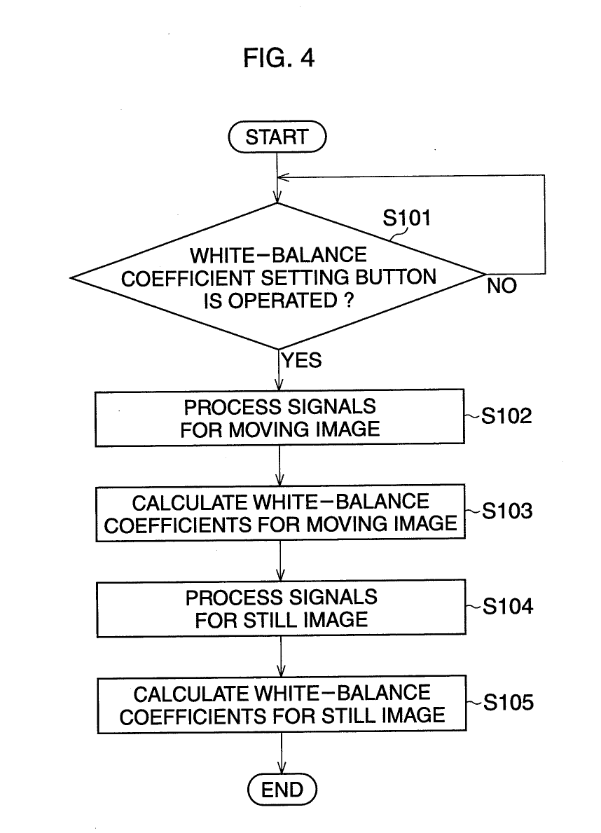

FIG. 4 is a flowchart of a white-balance coefficient operation process performed by the system control circuit 22.

In Step S101, it is determined whether the white-balance coefficient setting button 60 is pressed by the operator. Note that, the tip of the video scope 50 is herein inserted into the cylinder 80 in advance. When it is determined that the white-balance coefficient setting button 60 has been pressed, the process goes to Step S102. In Step S102, a control signal is sent from the system control circuit 22 to the scope controller 56 and the latter signal-processing circuit 28 to carry out the pixel mixture reading method and the signal process for a moving image.

In Step S103, R, G, and B color image signals, input to the white-balance adjustment circuit 34, are sent to the system control circuit 22. Then, white-balance coefficients for a moving image Kr, Kg, Kb, which are the R, G, and B gain values, are calculated. The white-balance coefficients for a moving image Kr, Kg, and Kb are calculated such that the ratio of the values of the R, G, and B color image signals is 1:1:1. The calculated white-balance coefficients Kr, Kg, and Kb are stored in the register of the white-balance adjustment circuit 34.

In Step S104, a control signal is output to carry out signal-reading and signal processing for obtaining a still image, to the scope-controller 56 and the latter signal-processing circuit 28. Then, in Step S105, white-balance coefficients for a still image Mr, Mg, and Mb are calculated. The white-balance coefficients for a still image Mr, Mg, and Mb are calculated such that the ratio of the values of the R, G, and B color image signals becomes 1:1:1. The calculated white-balance coefficients for as till image Mr, Mg, and Mb are stored in the register of the white-balance adjustment circuit 28. After Step S104 is carried out, the process is terminated and the normal observation mode is set again. Consequently, a moving image is displayed.

Thus, in the present embodiment, when the white-balance coefficient setting button 60 is operated, the image-pixel signals are read from the CCD 54 in accordance with the pixel mixing method first, and the white-balance coefficients (Kr, Kg, Kb) for a moving image are calculated on the basis of the R, G, and B color image signals, which are generated by using the matrix K. Furthermore, the image-pixel signals are read from the CCD 54 in accordance with the frame reading method for a still image, and the white-balance coefficients (Mr, Mg, Mb) for a moving image are calculated on the basis of the R, G, and B color-image signals, which are generated by using the matrix M. Then, during the observation, the white-balance adjustment process using the white balance coefficients (Kr, Kg, Kb) is carried out in the normal observation mode, and the white-balance adjustment process using the white balance coefficients (Mr, Mg, Mb) is carried out in the freeze operation.

The white-balance coefficients (Mr, Mg, Mb) can be obtained based on the signal-reading method for a still image. Therefore, an appropriately white-balance-adjusted moving image and still image can be obtained at once.

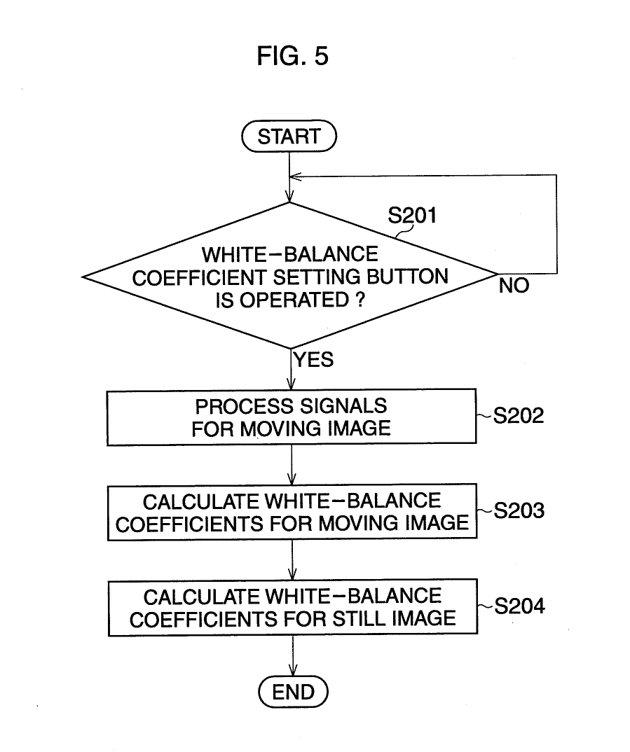

The second embodiment is explained with reference to FIG. 5. The second embodiment is different in that white-balance coefficients for a still image are calculated on the basis of white-balance coefficients for a moving image. Other constructions are substantially the same as those according to the first embodiment.

FIG. 5 is a flowchart of a white-balance coefficient operation process according to the second embodiment.

The processes of Steps S201 to S203 are the same as the processes of Step S101 to S103 in FIG. 4. Namely, when the white-balance coefficient setting button 60 is operated, the signal reading method and the signal process for a moving image are carried out, and the white-balance coefficients Kr, Kg, and Kb are calculated. Then, in Step S204, the white-balance coefficients Mr, Mg, and Mb are calculated on the basis of the white-balance coefficients Kr, Kg, and Kb for a moving image tighter with the correction coefficients Nr, Ng, and Nb. The correction coefficients Nr, Ng, and Nb are obtained by the following formula:

$$( \begin{matrix}N r \\ N g \\ N b\end{matrix} ) = ( \begin{matrix}( {k}_{11} + {k}_{12} + {k}_{13} + {k}_{14} ) / ( {m}_{11} + {m}_{12} + {m}_{13} + {m}_{14} ) \\ ( {k}_{21} + {k}_{22} + {k}_{23} + {k}_{24} ) / ( {m}_{21} + {m}_{22} + {m}_{23} + {m}_{24} ) \\ ( {k}_{31} + {k}_{32} + {k}_{33} + {k}_{34} ) / ( {m}_{31} + {m}_{32} + {m}_{33} + {m}_{34} )\end{matrix} ) \qquad ( 3 )$$

The correction coefficients (Nr, Ng, Nb) represent the ratio of the sum of the white-balance coefficients kᵢⱼ to the sum of the white-balance coefficients mᵢⱼ in a given row of the matrices K and M. Values of the correction coefficients (Nr, Ng, Nb) are taken as the ratio of the values of each color component in R, G, and B color image signals for a still image, to the values of the corresponding color component in the R, G, and B color-image signals for a moving image. Therefore, the correction coefficients (Nr, Ng, Nb) make the values of the R, G, and B color image signals obtained by the frame-reading method, equal to the values of the R, G, and B color image signals obtained by the method of pixel mixture reading.

The white-balance coefficients (Kr, Kg, Kb) for a moving image are multiplied by the correction coefficients (Nr, Ng, Nr) respectively, so that the white-balance coefficients (Mr, Mg, Mb) for a still image are obtained.

In this way, in the second embodiment, when the white-balance coefficient setting button 60 is pressed, the image-pixel signals are read from the CCD 54 in accordance with the pixel mixing method, and the white-balance coefficients (Kr, Kg, Kb) for a moving image are calculated. Then, based on the correction coefficients (Nr, Ng, Nb), obtained from matrices K and M, together with the white-balance coefficients (Kr, Kg, Kb), white-balance coefficients Mr, Mg, and Mb are calculated. In the normal observation mode, the white-balance adjustment process is carried out using white-balance coefficients Kr, Kg, and Kb. In the freeze operation, the white-balance adjustment process is carried out using white-balance coefficients Mr, Mg, and Mb.

As for the method of reading the image-pixel signals, other methods besides the one described above may be applied. In those cases, the signal reading method may be selected in accordance with the charge transfer method of the CCD (for example, the interleave method), the choice of color elements on the color filter (for example, a primary color filter), or the imaging method, etc.

The white-balance coefficients may be calculated automatically without the use of the button for setting the white-balance coefficient setting button. Also, the white-balance coefficients for a still image may be calculated first, and the white-balance coefficients for a moving image may be calculated afterwards. In the case of the first embodiment, the signal-reading method for a still image is carried out first, and subsequently the signal-reading method for a moving image is carried out. On the other hand, in the case of the second embodiment, white-balance coefficients Mr, Mg, and Mb for a still image may be obtained first, and then white-balance coefficients Kr, Kg, and Kb for a still image may be calculated on the basis of the white-balance coefficients (Mr, Mg, Mb) for a still image and the correction coefficients (Σm₁ⱼ/Σk₁ⱼ, Σm₂ⱼ/Σk₂ⱼ, Σm₃ⱼ/Σk₃ⱼ).

In the first embodiment, correction coefficients associated with a color adjustment process other than the white-balance adjustment process may be calculated.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2006-294367 (filed on Oct. 30, 2006), which is expressly incorporated herein, by reference, in its entirety.

1. An electronic endoscope comprising:
a video scope having an image sensor on which a subject image is formed by light passing through a color filter;
a first signal-reading processor that reads image-pixel signals from said image sensor in accordance with a first signal-reading method that obtains a moving image;
a second signal-reading processor that reads image-pixel signals from said image sensor in accordance with a second signal-reading method that obtains a still image;
a color-adjustment processor that carries out a color adjustment process to image signals generated from the image-pixel signals; and
a calculation processor that calculates first and second color-adjustment coefficients that are used in the color-adjustment process,
wherein said calculation processor calculates the first color-adjustment coefficients by operating said first signal-reading processor, and calculates the second color-adjustment coefficients by operating said second signal-reading processor.

2. The electronic endoscope of claim 1, wherein said calculation processor continuously calculates the first and second color adjustment coefficients in a one-time coefficient calculation process.

3. The electronic endoscope of claim 1, wherein said calculation processor calculates the first color-adjustment coefficients, and then calculates the second color-adjustment coefficients.

4. The electronic endoscope of claim 1, further comprising an operation member that is operated to start calculating the first and second color adjustment coefficients.

5. The electronic endoscope of claim 1, wherein the color filter is a complimentary color filter.

6. The electronic endoscope of claim 1, wherein said first signal-reading processor reads the image-pixel signals from said image sensor by a field-reading method.

7. The electronic endoscope of claim 1, wherein said second signal-reading processor reads the image-pixel signals from said image sensor by a frame-reading method.

8. An apparatus for calculating color-adjustment coefficients comprising:
a first signal-reading processor that reads image-pixel signals from said image sensor in accordance with one of a moving-image signal-reading method that obtains a moving image, and a still-image signal-reading method that obtains a still image;
a first calculation processor that calculates first color-adjustment coefficients used in a color-adjustment process on the basis of the image-pixel signals obtained by the first signal-reading processor;
a second signal-reading processor that reads image-pixel signals from said image sensor in accordance with another signal-reading method; and
a second calculation processor that calculates second color-adjustment coefficients on the basis of the image-pixel signals obtained by the second signal-reading processor.

9. A computer-readable medium that stores a program for calculating color-adjustment coefficients, the program comprising:
a first signal-reading process code segment that reads image-pixel signals from said image sensor in accordance with one of a moving-image signal-reading method that obtains a moving image, and a still-image signal-reading method that obtains a still image;
a first calculation process code segment that calculates first color-adjustment coefficients used in a color-adjustment process on the basis of the image-pixel signals obtained by the first signal-reading process code segment;
a second signal-reading process code segment that reads image-pixel signals from said image sensor in accordance with another signal-reading method; and
a second calculation process code segment that calculates second color-adjustment coefficients used in a color-adjustment process on the basis of the image-pixel signals obtained by the second signal-reading process code segment.

10. A method for calculating color-adjustment coefficients comprising:
reading image-pixel signals from said image sensor in accordance with one of a moving-image signal-reading method that obtains a moving image, and a still-image signal-reading method that obtains a still image;
calculating first color adjustment coefficients used in a color adjustment process on the basis of the image-pixel signals obtained by one signal-reading processor;
reading image-pixel signals from said image sensor in accordance with another signal-reading method; and
calculating second color adjustment coefficients on the basis of the image-pixel signals obtained by the other signal-reading method.
